(19) United States
(12) Patent Application Publication
(10) Pub. No.: US 2002/0095344 A1
(43) Pub. Date: Jul. 18, 2002

(54) Accounting and business transaction method and system

(76) Inventor: John F. Mares, Lansing, NY (US)

Correspondence Address: HANCOCK & ESTABROOK, LLP, 1500 MONY Tower I, PO Box 4976, Syracuse, NY, 13221-4976, US

(21) Appl. No.: 10/041,265

(22) Filed: Jan. 8, 2002

Related U.S. Application Data
(60) Provisional application No. 60/261,389, filed on Jan. 12, 2001.

(51) Int. Cl. G06F 17/60

(52) U.S. Cl. 705/21

(57) ABSTRACT

A system and method of accounting and auditing financial transactions, which are given a unique transaction number at the point-of-sale. Each financial transaction number identifies the particular transaction. A predetermined and predictable number is permanently assigned to each transaction. This predetermined number would be accompanied by information indicating the customer, the amount of the transaction, identifying the type of the transaction, the date, and the point-of-sale site.

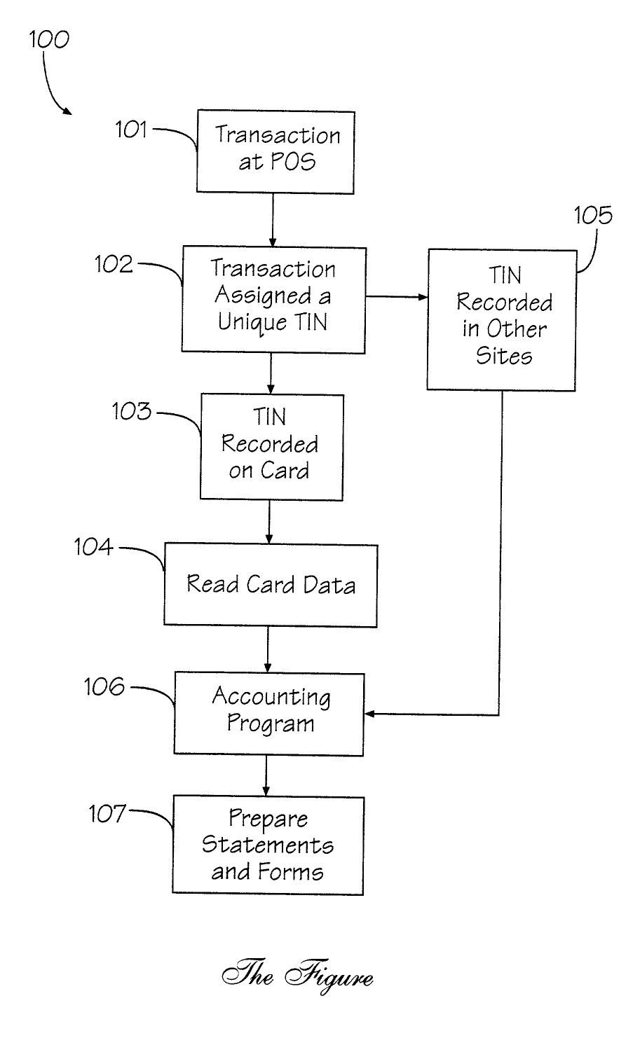

### RELATED APPLICATIONS

This application claims priority from U.S. Provisional Patent Application, Serial No. 60/261,389, filed Jan. 12, 2001.

This application is related to the copending U.S. patent application, Ser. No. ______ (AXI-173), filed ______, and assigned to a common assignee.

### FIELD OF THE INVENTION

The present invention relates to methods of accounting for business transactions and, more particularly, to a new system and method of identifying and processing every business and sales transaction in a unique manner, without the need for manual entry of the data and information beyond the point-of-sale, and which allows for a completely paperless entry and retrieval of data and information for accounting and auditing purposes.

### BACKGROUND OF THE INVENTION

Many software packages handle an individual's finances, one of which is the well-known Quicken program. The program automates accounting procedures such as writing checks, tracking expenses, tracking transactions in business, or personal bookkeeping.

The disadvantage of these automated accounting programs is that they all require manual entry of the data from a sales receipt or other physical records and receipts provided from banks and credit card companies. The manual processes of entry and reconciliation of receipts is both tedious and time consuming, and prone to human errors.

More recently, a system has been implemented in the Sears, Roebuck & Company stores, wherein successive sales transactions are each encoded with a series of bar codes. Each successive transaction has an indexed transaction number. Another bar code of the transaction contains information of the particular store. A third bar code identifies the sales terminal. Subsequently, the bar codes can be machine read, and the information stored for accounting purposes.

Most recently, a system has been developed for a point-of-sale (POS) terminal, which identifies each sales transaction with an unpredictable code. The system is described in U.S. Pat. No. 5,969,324, issued to Reber et al. on Oct. 19, 1999, for ACCOUNTING METHODS AND SYSTEMS USING TRANSACTION INFORMATION ASSOCIATED WITH A NONPREDICTABLE BAR CODE. The system prints a bar coded receipt of the sales transaction having the unpredictable number identifying the sale. Subsequently, the information of the sale is transferred to a transaction system that downloads and reads the transaction information.

### SUMMARY OF THE INVENTION

In accordance with the present invention, there is a transaction method and system wherein each consumer or business person carries a magnetic smart card. This smart card is generally the size of a credit card. The smart card can also be a modified credit card having the capability to record specific transaction details in magnetic memory. The specifics of each transaction would include the name of the vendor, vendor address, consumer name, consumer address, company name, company address, transaction date, transaction type code (perhaps as designated by the IRS), transaction amount, transaction tax amount, items purchased, and a unique transaction identifying number (TIN) for each transaction.

The method of the invention contemplates presenting the aforementioned smart card to the vendor at the point-of-sale, who then inserts the card into a smart card encoding device. The encoding device can be a receipt printer or a magnetic card writer, which inputs the specific transaction details into the smart card. Afterwards, the consumer inserts the smart card into a smart card reader, which is connected to a computer. The smart card reader downloads the transaction details to a spreadsheet, accounting, or tax software program, which can also acquire the details of the transaction from the vendor by electronic communication means, such as Internet downloads, or from a commercial bank computer or, in some special cases, from a user IRS file. It is contemplated that the vendor computer will be in communication with these other computers for purposes of credit, storage, verification of records, and other financial purposes that befit the modern commercial community.

The accounting program recognizes and posts the transaction details in proper accounting and tax order. It then prepares reports and forms related to the transactions of the consumer, including expense reports, expense statements, and tax forms, such as an IRS Schedule C.

The invention provides a method and system for accounting for business and sales transactions, without the need to manually input the data beyond the initial transaction input at the point-of-sale.

The TIN will identify every business transaction with a predetermined and predictable number. This predetermined number will be a unique number that can be tracked for purposes of internal revenue accounting and auditing. Every person can be traced to a particular transaction, whether buying an airline ticket, renting a hotel room, purchasing a gift, etc.

This information could also be encoded on receipts that later could be machine readable. However, in a larger sense, the need for receipts will be made unnecessary and obsolete by the present invention. The information will be stored at a transaction terminal, then transferred to a master terminal for internal revenue purposes or a terminal for banking purposes. The data and information would also be sent to an individual's computer via the Internet or retrievable by an individual from a central data base terminal specific to his account. Processing using Quicken or some other personal accounting software would require no manual entry of data or scanning information into the home computer. The individual would merely download his transaction history from his smart card or from a central source keyed to his personal account number.

It should be realized, however, that all the transactions will be stored at various different sites, such that any loss of information would be immediately identifiable and retrievable by accessing an alternate data site.

It is an object of this invention to provide a system and method for improving accounting and auditing of transactional data and information.

It is another object of the invention to provide a system and method for accounting and auditing that is keyed to a predetermined, predictable transaction number or TIN.

### BRIEF DESCRIPTION OF THE DRAWINGS

A complete understanding of the present invention may be obtained by reference to the accompanying drawings, when considered in conjunction with the subsequent detailed description, in which:

The FIGURE illustrates a flow chart in accordance with the method and system of this invention.

### DESCRIPTION OF THE PREFERRED EMBODIMENT

Generally speaking, the invention is for a system and method of accounting and auditing financial transactions, which are given a unique transaction identifying number or TIN at the point-of-sale.

Each financial transaction number identifies the user, the vendor, the type, and the amount of the purchase. Each TIN will be a predictable number that is permanently assigned to each individual transaction.

Now referring to the FIGURE, a flow diagram 100 is illustrated, which depicts the method and system of this invention. A customer making a purchase, or conducting a business transaction at the POS in accordance with the invention presents his smart card to the vendor, step 101. This smart card is generally the size of a credit card. The smart card can also be a modified credit card having the capability to record specific transaction details in magnetic memory. The specifics of each transaction would include the name of the vendor, vendor address, consumer name, consumer address, company name, company address, transaction date, transaction type code (perhaps as designated by the IRS), transaction amount, transaction tax amount, items purchased, and a unique transaction identifying number (TIN).

This predetermined TIN number is assigned, step 102 and recorded in the computer of the vendor. It is also magnetically encoded into the smart card presented by the customer at the point-of-sale step 103. The recorded information in effect presents this unique number that can be tracked for purposes of internal revenue accounting and auditing. Every person can be traced to a particular transaction, whether buying an airline ticket, renting a hotel room, purchasing a gift, etc.

The card is inserted into a smart card encoding device. The encoding device can be a receipt printer or a magnetic card writer, which inputs the specific transaction details into the smart card. Afterwards, the consumer inserts the smart card into a smart card reader, which is connected to a home or business computer, step 104.

The smart card reader downloads the transaction details to a spreadsheet, accounting, or tax software program, referred to as the accounting program, step 106. This accounting program can also acquire the details of the transaction from the vendor by electronic communication means, such as Internet downloads, or from a commercial bank computer, or in some special cases, from a user IRS file step 105. It is contemplated that the vendor computer will be in communication with these other computers for purposes of credit, storage, verification of records, and other financial purposes that befit the modern commercial community.

The accounting program recognizes and posts the transaction details in proper accounting and tax order. It then prepares reports and forms related to the transactions of the consumer including expense reports, expense statements, and tax forms, such as an IRS Schedule C, step 107.

The invention provides, for the first time, a method and system for accounting for business and sales transactions without the need to manually input the data beyond the initial transaction input at the point-of-sale.

As aforementioned, the TIN will identify every business transaction with a predetermined and predictable number. This predetermined number will be a unique number that can be tracked for purposes of internal revenue accounting and auditing. Every person can be traced to a particular transaction, whether buying an airline ticket, renting a hotel room, purchasing a gift, etc.

This information could also be encoded on receipts that later could be machine readable. However, in a larger sense, the need for receipts will be made unnecessary and obsolete by the present invention. The information is stored at the POS transaction terminal, then transferred to a master terminal for internal revenue purposes or a terminal for banking purposes, step 105. The data and information is also sent to an individual's computer via the Internet or retrievable by an individual from a central data base terminal specific to his account. Processing using Quicken or some other personal accounting software would require no manual entry of data or scanning information into the home computer, step 106. The individual would merely download his transaction history from his smart card, step 104, or from a central source keyed to his personal account number, step 105.

It should be realized, however, that all of the transactions will be stored at various different sites, such that any loss of information would be immediately identifiable and retrievable by accessing an alternate data site.

Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Having thus described the invention, what is desired to be protected by Letters Patent is presented in the subsequently appended claims.

What is claimed is:

1. A method of paperless accounting of financial transactions, comprising the steps of:
a) making financial transactions at a point of sale;
b) assigning a unique transaction number to each transaction that will identify the transaction;
c) storing said transaction numbers at a number of storage sites, including the point of sale site; and
d) retrieving said transaction numbers for the purposes of accounting for said financial transactions.

2. The method in accordance with claim 1, further comprising the step of:
a) printing a statement based upon said financial information.

3. The method in accordance with claim 1, further comprising the step of:
a) printing a form based upon said financial information.

4. The method in accordance with claim 1, wherein said storing step (c) further comprises the step of:
a) storing each of said transaction numbers on a smart card.

5. The method in accordance with claim 1, further comprising the step of:
a) accessing said transaction numbers to perform internal revenue accounting or auditing.

6. The method in accordance with claim 1, further comprising the step of:
a) sending said transaction numbers via the Internet.

7. The method in accordance with claim 1, wherein said retrieving step (d) further comprises the step of:
a) accessing a particular storage site.

8. The method in accordance with claim 1, wherein said retrieving step (d) further comprises the step of:
a) accessing more than one storage site.

9. The method in accordance with claim 1, wherein said assigning step (b) comprises a unique transaction number including information comprising:
a) identifying the purchaser;
b) identifying the type of transaction;
c) identifying the point of sale;
d) identifying a date of the financial transaction; and
e) an amount of the financial transaction.

10. A method of processing financial transactions, comprising the steps of:
a) making a financial transaction at a point of sale;
b) assigning a unique encoded TIN number to said transaction that will identify the transaction;
c) storing said encoded TIN number at a number of storage sites, including the point of sale site; and
d) retrieving said encoded TIN number for the purposes of processing said unique encoded TIN number.

11. The method in accordance with claim 10, further comprising the step of:
a) printing a statement based upon said financial information.

12. The method in accordance with claim 10, further comprising the step of:
a) printing a form based upon said financial information.

13. The method in accordance with claim 10, wherein said storing step (c) further comprises the step of:
a) storing each of said transaction numbers on a smart card.

14. The method in accordance with claim 10, further comprising the step of:
a) accessing said transaction numbers to perform internal revenue accounting or auditing.

15. The method in accordance with claim 10, further comprising the step of:
a) sending said transaction numbers via the Internet.

16. The method in accordance with claim 10, wherein said retrieving step (d) further comprises the step of:
a) accessing a particular storage site.

17. The method in accordance with claim 10, wherein said retrieving step
a) further comprises the step of:
b) accessing more than one storage site.

18. The method in accordance with claim 10, wherein said assigning step (b) comprises a unique transaction number including information comprising:
a) identifying the purchaser;
b) identifying the type of transaction;
c identifying the point of sale;
d) identifying a date of the financial transaction; and
d) an amount of the financial transaction.
